(19) United States
(12) Patent Application Publication
(10) Pub. No.: US 2009/0077137 A1
(43) Pub. Date: Mar. 19, 2009

(54) METHOD OF UPDATING A VIDEO SUMMARY BY USER RELEVANCE FEEDBACK

(75) Inventors: Johannes Weda, Eindhoven (NL); Mauro Barbieri, Eindhoven (NL); Marco Emanuele Campanella, Eindhoven (NL); Sander Wilhelmus Johannes Kouwenberg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,129

(22) PCT Filed: Apr. 26, 2007
(86) PCT No.: PCT/IB07/51543

§ 371 Date: Oct. 31, 2008

(30) Foreign Application Priority Data
May 5, 2006 (EP) 06113539.8

(51) Int. Cl. G06F 17/30

(52) U.S. Cl. 707/200; 707/E17.005

(57) ABSTRACT

Method of updating an initial summary (110) of a content item (100) that comprises a plurality of segments (101a . . . 101l) each having a respective initial importance score. The initial summary (110) comprises a subset of the plurality of segments of the content item (100) that have been selected based on their respective importance scores. The method comprises receiving user feedback (301) for a selected segment of the initial summary (110); determining a degree of influence of each of the plurality of the content characteristics (201) on importance scores based on the received user feedback (301), said degree of influence affecting the derivation of the importance score for a given segment based on the content characteristics (201) corresponding to the selected segment; deriving updated importance scores of at least part of the plurality of segments pertaining to the content item based on the adjusted degrees of influences of the content characteristics (201); and updating the summary by updating the subset of the plurality of segments based on their respective updated importance scores.

The invention relates to a method of updating an initial summary of a content item that comprises a plurality of segments each having a respective initial importance score. The initial summary comprising a subset of the plurality of segments of the content item that have been selected based on their respective importance scores.

Availability and affordability of consumer devices equipped with the video capturing functionality have increased in recent years. This enables users to record many events they experience in their lives. This in turn results in an enormous amount of audiovisual material that is produced by a single user. Watching of the full-length recordings can be quite time consuming and boring as the interesting audiovisual material is mixed with less appealing audiovisual material. Various techniques have been developed to create a summary of an arbitrary audiovisual content item.

The patent application WO 2005/119515 A1 (attorney docket PHNL040728) discloses a method and an electronic device for enabling dynamically affecting a summary of a multimedia stream, where the method comprises the steps of presenting the summary to a user, obtaining user input related to topics appearing at least in the multimedia stream from the user, and updating the summary in relation to at least the obtained user input, so that the summary can be changed and presented to a user. The topics are enclosed in a Meta data stream containing descriptors of the content, such as topics or attributes of the basic multimedia stream. This Meta data stream for this reason is associated with the basic multimedia stream.

A disadvantage of the above method and electronic device is that they need to have meta data prepared beforehand and present in the multimedia stream in order to update the summary. This Meta data needs to be prepared for an arbitrary multimedia content. Furthermore the Meta data must be acquired, which means that an additional stream of data needs to be received and processed. Moreover, providing the user input navigating the Meta data is rather tedious and inconvenient.

It is an object of the invention to provide a method of updating an initial summary of a content item that does not require the Meta data corresponding to the content item in order to update the summary.

This object is achieved according to the invention in a method as stated above, characterized by: receiving user feedback for a selected segment of the initial summary, determining a degree of influence of each of the plurality of the content characteristics on importance scores based on the received user feedback, said degree of influence affecting a derivation of the importance score for a given segment based on the content characteristics corresponding to the selected segment, deriving updated importance scores of at least part of the plurality of segments pertaining to the content item based on the adjusted degrees of influences of the content characteristics, and updating the summary by updating the subset of the plurality of segments based on their respective updated importance scores.

When making a summary, segments are selected based on their content characteristics. Each characteristic has a certain degree of influence in the selection. For example, brightness and audio level could be an important factor for selection, but amount of red levels in the video less so. According to the invention, based on the user feedback the content characteristics of the selected segment are evaluated and the degrees of influence of the characteristics of the selected segment are adjusted based on the evaluation. For example, if the selected segment has a low brightness level, and the user expresses a positive feedback, the importance of brightness could be reduced. Subsequently new importance scores are derived for the segments using the adjusted degrees of influence of the various content characteristics. With the new importance score an updated summary that is better tailored to the preferences of the user is created. Because only content characteristics are taken into account, no Meta data is required to update the summary.

In an embodiment, the user feedback comprises an indication whether the user likes or dislikes the segment. This enables a simple and intuitive way of interaction with the user.

In another embodiment, the segment for which the user feedback is received is selected as a segment at which the summary has been paused when the feedback is being received. This enables a focused way of providing the user feedback, as no ambiguity occurs to which segment a provided feedback refers to.

In another embodiment, in the updated summary only segments from the segment on which the feedback is provided until the end of the summary are updated. This allows the user to preserve the updated part of the summary that has already been approved, and to update only this part of the summary that the user has not seen yet.

In another embodiment, a method is claimed enabling the user to shorten or extend the summary by adding or removing of at least one segment adjacent to the selected segment. This enables the user to extend a content of its feedback. Instead of plain like/dislike there is more information conveyed in the user feedback. Namely, the user likes the specific segment so much that a shot comprising this segment should be extended. On the other hand, the user dislikes the specific segment so much that the shot comprising this segment should be shortened.

In another embodiment, the size of the summary is preserved by automatic adding or removing of segments. This provides an additional constraint for the selection of segments to be incorporated into updated summary. Basically it prevents the summary to become too long or too short.

In another embodiment, the summary is implemented as a play list of segments. The play list of segments is an efficient manner of implementing the summary. Any new update of summary requires the update of a list of segment indicators without any processing of the audiovisual content item.

The invention further provides a device for use in the method according to the invention. Advantageous embodiments of method and device are set out in dependent claims.

These and other aspects of the invention will be apparent from and elucidated with reference to the embodiments shown in the drawings, in which:

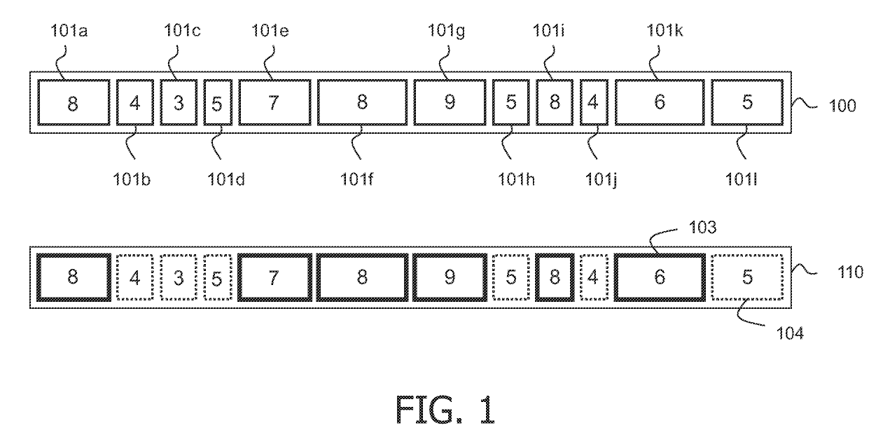

FIG. 1 schematically shows a content item with a corresponding initial summary;

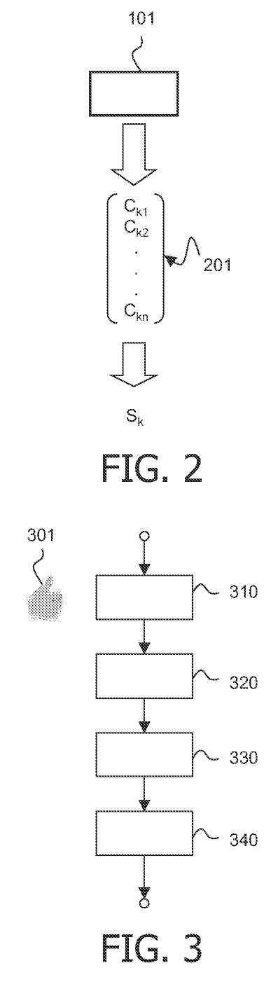

FIG. 2 illustrates the dependence of an initial importance score corresponding to a segment on a plurality of content characteristics corresponding to said segment;

FIG. 3 shows a flow chart of the proposed method of updating the initial summary;

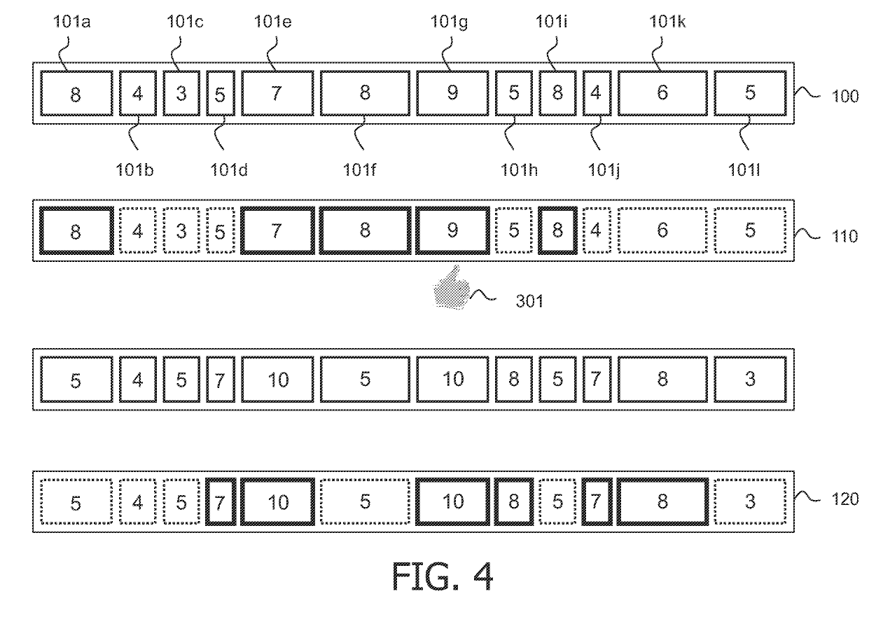

FIG. 4 shows an effect of a user feedback on an updated summary;

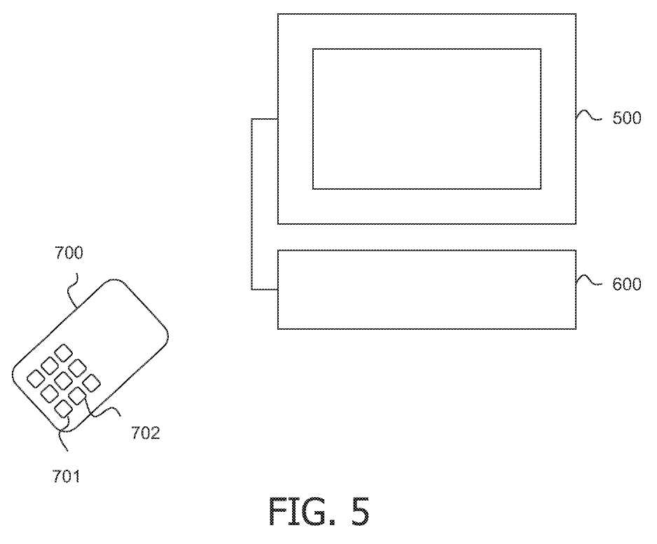

FIG. 5 shows an example of a set-up of devices in which a summary update can be realized;

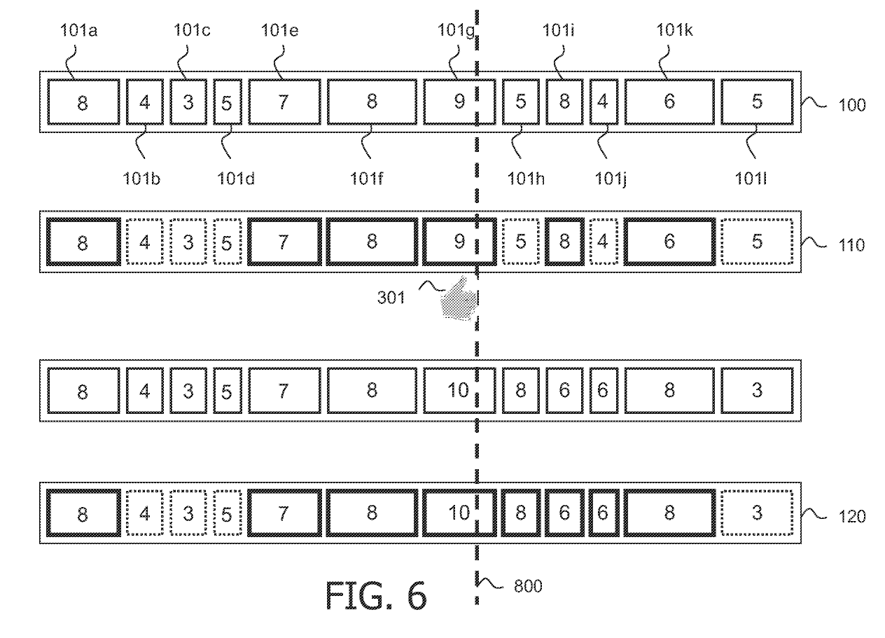

FIG. 6 shows an example of a partial update of the summary in which only segments from the segment on which the feedback is provided until the end of the summary are updated;

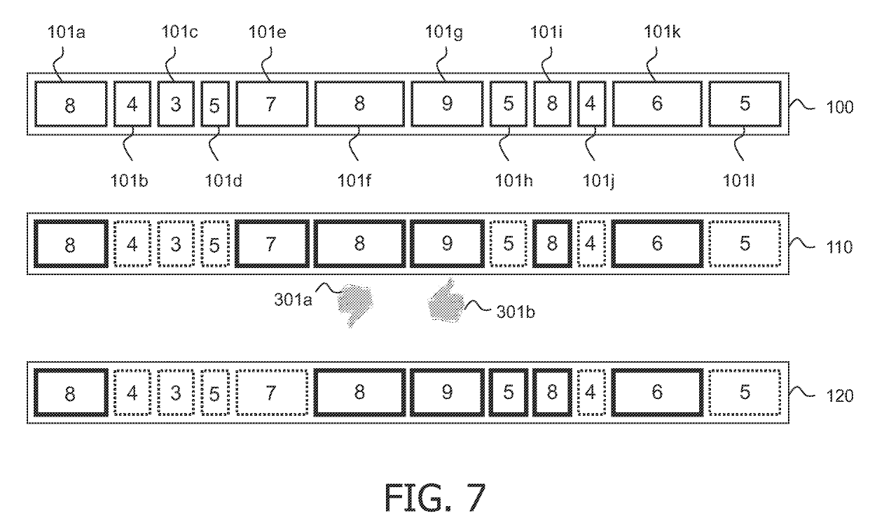

FIG. 7 illustrates an example in which the updated summary is shortened or extended by removing or adding of at least one segment adjacent to the selected segment;

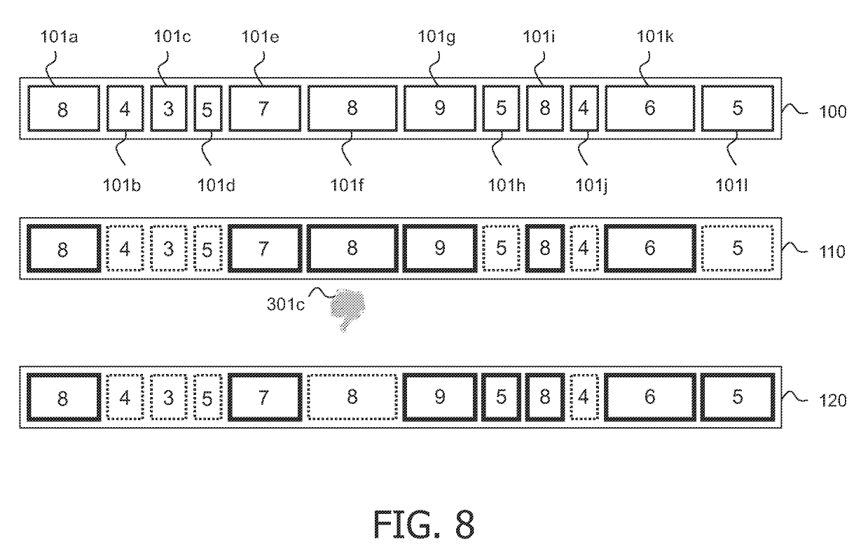

FIG. 8 illustrates an example in which the size of the summary is substantially preserved by adding or removing of segments;

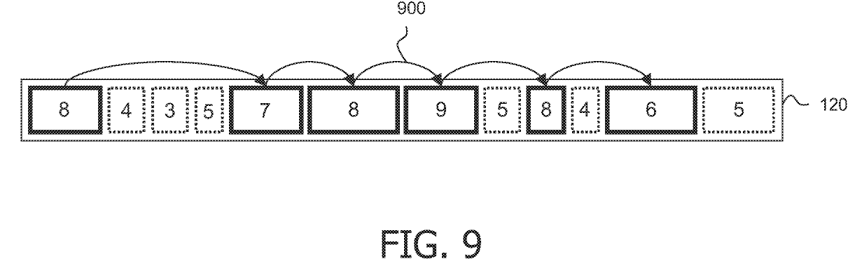

FIG. 9 illustrates an implementation of a summary as a play list of segments.

Throughout the figures, same reference numerals indicate similar or corresponding features. Some of the features indicated in the drawings are typically implemented in software, and as such represent software entities, such as software modules or objects.

FIG. 1 schematically shows a content item 100 with a corresponding initial summary 110. The content item 100 comprises a plurality of segments ranging from the first segment 101a till the end segment 101l. There are numerous well-known ways to determine segments. One of the alternatives is to determine segments manually. Another alternative is to automate the segmentation by using, for example, the method described in Yeung, MM and Liu, B, “Efficient matching and clustering of video shots”, Int. Conf. on Image Processing, pp. 338-341, 1995. The segmentation methods mentioned above are just examples, and other methods are also possible.

Each of the segments pertaining to the content item has a respective initial importance score that is indicated by a numeral enclosed in boxes representing segments. These importance scores are either subjective scores or objective scores of the segment importance. The subjective scores are the scores that are introduced manually and reflect directly someone's judgment, for example the director or composer of the content item. Alternatively, the objective scores are calculated based on the content enclosed in the segments with no intervention by a human. This aspect of the invention will be discussed with reference to FIG. 2.

The initial summary 110 comprises a subset of the plurality of segments of the content item that have been selected based on their respective importance scores. The segment 103 is one of the selected segments. The thick solid line of a box of the segment 103 indicates that this segment has been selected for the summary. The dashed line of the box of the segment 104 indicates that this segment has not been selected for the summary.

In the example shown in FIG. 1, the initial summary comprises all segments that have the importance score greater than 5. Using a threshold, in this case a value of 5, for selecting the summary segments is just one of many alternatives. Other criteria could also be used to select segments for the summary. For example a subset comprising a fixed number of segments could be chosen such that the selected segments have the top importance scores. Yet another option is to select a subset of segments having the top importance scores such that the total size corresponding to the selected segments is closest to the predetermined size of the summary. Many other select criteria are also possible.

The content item preferably comprises an audiovisual content. The content item preferably comprising: music, video, movie, clip, multimedia content, graphics, etc.

FIG. 2 illustrates the dependence of an initial importance score corresponding to a segment 101 (one of 101a, . . . , 101l) on a plurality of content characteristics 201 corresponding to this segment. The term content characteristic refers to characteristics of the content itself, and not to a description or other meta-data associated with this content. Some examples of content characteristics are: luminance level, hue and saturation level, audio volume level, audio classification (speech, music, noise, crowd, etc), speech detection and sentence boundary detection, camera motion (pan, tilt, zoom, etc.), motion blur, focus blur, shot type (long, short, close up, etc.), face detection, and many others. On the other hand, items such as title, director, actors, keywords for content or a segment of the content are not content characteristics as that term is used in the present document. Each of these content characteristics can be measured for the content comprised in the segment 101 and a value can be given to each of the plurality of the content characteristics, which is relative to some predetermined maximum.

Usually, the segment comprises, for example, a series of frames. The values of the content characteristic could be, for example, an arithmetic average or minimum of the values of the content characteristic that correspond to frames pertaining to the segment. Alternatively, such an average could be calculated for a specific subset of frames. For example, for a predetermined number of frames which are evenly spaced within the segment, or for frames that are considered as representative for the segment based on their content. Methods of calculating the content characteristic values corresponding to the segment 101 are well known.

In order to measure certain content characteristics related to the content it might be necessary to decode the content completely or partially. The formats used for audiovisual content often forthcoming in the contemporary devices with the camcorder functionality are: MPEG2, MPEG4, or DV (Digital Video). However, other formats are not excluded.

It should be noted that Meta data associated with the content is not a content characteristic, as the term content characteristic is to be understood as a measurable characteristic property of the audiovisual content and not as the description of the content. The content characteristics 201 are directly derived from the content and are by no means related to a Meta data.

However, it should not be excluded that the proposed method of updating the summary could use an additional selecting criterion based on the Meta data corresponding to the content item. However, in such a case the Meta data, although content dependent, is provided by a separate Meta data item corresponding to the content item comprising the audiovisual content.

Based on the plurality of content characteristics 201 corresponding to the segment 101 the initial importance score is derived for the segment 101. It is an initial importance score purely based on the content characteristics, as no feedback from the user is yet available about whether the segment is preferred by the user.

The initial importance score is calculated according to some particular algorithm. Calculation of the importance scores is discussed, for example, in Barbieri M., Weda H., Dimitrova N., “Browsing Video Recordings Using Movie-in-a-Minute”, Proc. of the IEEE International Conference on Consumer Electronics, ICCE 2006, pp. 301-302, Jan. 7-11, 2006, Las Vegas, USA.

FIG. 3 shows a flow chart of the proposed method of updating the initial summary. In the first step 310 the initial summary is created or retrieved. In the second step 320 the degree of influence of each of the plurality of the content characteristics on the importance scores is determined based on a user feedback 301. In the third step 330 the importance scores corresponding to the segments pertaining to the content item are updated. In the fourth step 340 the updated summary is created by updating the subset of plurality of segments based on their respective updated importance scores.

Each time the user provides his feedback 301 on the selected segment, a degree of influence of each of the content characteristics 201 based on this feedback is adjusted. The degree of influence affects the derivation of the importance score. The gradation of the influence can be done through adapting, for example, weight coefficients corresponding to each of the plurality of content characteristics. The adapted weight coefficients are then used to update the importance scores of the segments pertaining to the content item.

In one embodiment each weight coefficient is assigned to each of the plurality of content characteristics 201. Subsequently an inner product of the vector comprising the weight coefficients [w₁ w₂ . . . wₙ] with the corresponding vector comprising the plurality of content characteristics 201 can serve the purpose of the importance score sₖ:

$${s}_{k} = [ \begin{matrix}{w}_{1} & {w}_{2} & … & {w}_{n}\end{matrix} ] [ \begin{matrix}{c}_{k 1} \\ {c}_{k 2} \\ … \\ {c}_{kn}\end{matrix} ]$$

Other ways of calculating the importance scores from the plurality of content characteristics are also possible. For example, some algorithms make use of content characteristic dependencies corresponding to similar characteristic categories. For example, content characteristics corresponding to video could contribute in another way to the importance score than those corresponding to audio.

The plurality of content characteristics 201 is calculated only once and does not change during updating of the summary. The weight coefficients capture the user feedback and are changing during the updating of the summary along with the received user feedback.

FIG. 4 shows an effect of a user feedback 301 on the updated summary 120. In the figure the content item 100 and an initial summary 110 that comprises a subset of segments selected based on their initial importance scores, dependent on the plurality of content characteristics 201, are shown.

While watching the user gives his feedback 301 on the fourth segment in the summary 110 that corresponds to the seventh segment 101g in the content item 100. The user indicates with his feedback 301 that he likes the current segment he is seeing. Based on this feedback the degree of influence of each of the plurality of content characteristics 201 is determined, and the importance scores using the adjusted degrees of influence and the values of the plurality of the content characteristics are derived. Some of the importance scores increase, some decrease, and some remain unchanged. For example, the importance score of the currently seen segment 101g increases from a value 9 to 10. The importance score corresponding to the segment 101k of the content item increases from a value 6 to 8.

Assuming that all segments having the importance scores exceeding the threshold of 5 are selected for the summary, the updated summary 120 differs substantially from the initial summary. Only two segments that were present in the initial summary 110 are still present in the updated summary 120.

The user can choose to further tailor the summary to his personal preferences and therefore he could choose to perform another update iteration. In this next iteration the previously updated summary serves the purpose of the initial summary.

In each update iteration through the initial summary a user can choose whether he wants to update the summary after each of his individual feedback, or to collect his feedbacks he has provided for the entire summary and only then to update the importance scores and the summary.

FIG. 5 shows an example of a set-up of devices in which a summary update can be realized. A device 600 is used to create or retrieve the initial summary 110 and to create the updated summary 120 based on user feedback 301. A device 500 is used to present the summary to the user. The feedback 301 from the user is provided using for example a remote control device 700. The feedback of liking or disliking the segment that is currently displayed at the device 500 is provided by means of, for example, pressing buttons. For a positive feedback, which means liking, about the segment the button 701 is pressed, while for a negative feedback, meaning disliking, the button 702 is pressed. A well-known example of such button is the thumbs-up/down buttons on TiVo™ remote control.

The user feedback 301 can be provided during the presentation of the summary. In such a case the user must be cautious to provide timely feedback so that it is received during playing the segment to which the issued feedback corresponds. The user can also choose to pause the playback of the summary within the segment in order to provide the feedback. In this case there is no ambiguity possible about to which segment the received user feedback belongs.

The user feedback could also be more complex than just a simple binary like/dislike feedback. For example, when the selected segment is paused a number of times the button 701 is pressed, or the duration of the period the button 701 is being pressed, could serve for the measure of how much the user likes the selected segment. The same holds for the button 702. The larger the number of times the button is pressed, or the longer the period in which the button remains pressed is, the less likable the selected segment is.

It is possible that the feedback 301 has also another meaning, for example, it prescribes extending or shortening of a shot (this will be discussed with reference to FIG. 7), or it explicitly prescribes removing of the selected segment (this will be discussed with reference to FIG. 8).

For all these additional options designated buttons to provide these specific types of the feedback can be assigned on the remote control device 700. Furthermore, for adding an additional segment a dedicated graphical user interface is provided. This interface shows the user an overview of segments, which are not included in the summary. A segment can be represented by means of a list of representative images or key-frames.

It is also possible that a graphical user interface is provided to the user in order to receive more extended user feedback, which not only provides grading of the feedback, but also allows setting of the user feedback for each of the plurality of the content characteristics.

FIG. 6 shows an example of partial update of the summary 110 in which only segments from the segment 101g on which the feedback 301 is provided onwards until the end of the summary 101l are updated. It is reasonable to assume that the user that provides the feedback 301 is satisfied with the summary 110 that he has seen until the selected segment 101g. In other words he likes the summary until the time border 800. In such a case the update of the summary can be applied to only the segments that follow the selected segment 101g. The importance scores of the segments in the subset comprising the content item from the selected segment till the end segment of the content item are updated to incorporate the user feedback 301. Subsequently, the selection of the segments from this subset of segments is made for the updated part of the summary.

The selection of the segments for the updated part of the summary that is applied to the updated importance scores might require adjusting the threshold that is used to derive the subset of segments with the highest importance scores. Alternatively, the time constraint corresponding to the total time of the summary could be taken into account when selecting the segments for the updated part of the summary.

If the user decides to perform yet another update iteration on the summary, the importance scores of the first part of the content item from the first segment till the selected segment on which the time border has been set are updated to incorporate the effect of the user feedback.

FIG. 7 illustrates an example in which the updated summary 120 is shortened or extended by removing or adding of at least one segment adjacent to the selected segment. The user feedback 301a indicates that the user would like to shorten the shot to which the selected segment belongs. The shot is here understood as a sequence of segments that corresponds to a continuous shot of the camera.

Assume that the shot comprises three consecutive segments with the selected segment in the middle. The segments adjacent to the selected segment have the importance scores of 7 and 9. To fulfill the user desire to shorten the shot the segment with the lower importance score is removed from the summary.

Assuming that the segment with the lower score, to the left of the selected segment, belongs to another shot than the one to which the selected segment belongs, the segment with the lower score remains in the summary and the segment that is adjacent to the right of the selected segment is removed.

Alternatively another lowest segment with the lowest importance score in the shot could be selected. In this case the selected segment is deleted and the neighboring segment with the higher importance score remains in the summary. The summary commences from the beginning of the following segment.

The user feedback 301b indicates that the user would like to extend the shot to which the selected segment belongs. Since the shot can only be extended to the right of the selected segment, the segment adjacent on the right and belonging to the same shot is added to the summary. The fact that the importance score of the added segment is lower than the prescribed threshold used for the summary selection is irrelevant.

The removal and addition of segments other than the selected segment although not directly is still related to the user feedback provided for the selected segment. Therefore, the importance scores of the segments are updated assuming that the user has provided an explicit feedback of dislike for the deleted segment and an explicit feedback of like on the added segment.

FIG. 8 illustrates an example in which the size of the summary 110 is substantially preserved by adding or removing of segments. The user might choose to give a time constraint for the total duration of the summary. In such a case, when the user provides the feedback 301c to delete the selected segment, as illustrated in the figure, additional segments are added to provide the summary with the targeted size. The segments that are added are the segments with the highest scores selected from the subset of the content item segments that were not selected for the initial summary. To compensate the deleted segment the segments 101h and 101l of the content item are added.

The size is one of the following types: time duration or storage size. Furthermore, the user is provided with the means to set the total size. This is done using for example the remote control 700 shown in FIG. 5. The software at the device 600 should be adapted so that the user is provided with, for example, a graphical user interface presented at the device 500.

FIG. 9 illustrates an implementation of a summary 110 or 120 as a play list of segments. It is a quite efficient way of implementing the summary as it enables a re-use of a segment partitioning of the content item 100 as well as a re-use of the plurality of the content characteristics 201 corresponding to segments without the need of their recalculation. Furthermore, it enables easy backtracking of the user iterations applied on the summary and undoing some of user decisions concerned with the user feedback on certain segments. Furthermore, it reduces the storage required for storing the summary to the storage required for pointers 900 to consecutive segments of the summary in the context of the content item. This however under condition that the segmented content item is stored somewhere else and readily available.

It should be noted that the above-mentioned embodiments illustrate rather than limit the invention, and those skilled in the art will be able to design many alternative embodiments without departing from the scope of the appended claims. For instance, instead of audiovisual content item the audio item could be used.

In the accompanying claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. Method of updating an initial summary (110) of a content item (100) that comprises a plurality of segments (101a . . . 101l) each having a respective initial importance score, the initial summary (110) comprising a subset of the plurality of segments of the content item (100) that have been selected based on their respective importance scores, characterized by:
receiving user feedback (301) for a selected segment of the initial summary (110);
determining a degree of influence of each of the plurality of the content characteristics (201) on importance scores based on the received user feedback (301), said degree of influence affecting the derivation of the importance score for a given segment based on the content characteristics (201) corresponding to the selected segment;
deriving updated importance scores of at least part of the plurality of segments pertaining to the content item based on the adjusted degrees of influences of the content characteristics (201); and
updating the summary by updating the subset of the plurality of segments based on their respective updated importance scores.

2. The method as claimed in claim 1, wherein the user feedback (301) comprises an indication whether the user likes or dislikes a segment.

3. The method as claimed in claim 1, wherein the segment for which the user feedback is received is selected as a segment at which the summary has been paused when the feedback (301) is being received.

4. The method as claimed in claim 1, wherein the degree of influence is implemented as a weight coefficient.

5. The method as claimed in claim 1, wherein in the updated summary (120) only segments from the segment on which the feedback (301) is provided until the end of the summary are updated.

6. The method as claimed in claim 1, further enabling a user to shorten or extend the summary by adding or removing of at least one segment adjacent to the selected segment.

7. The method as claimed in claim 1, further enabling the user to add a segment to the summary, said segment being selected from the subset of segments, which are not pertaining to the current summary.

8. The method as claimed in claim 1, wherein the size of the summary is preserved.

9. The method as claimed in claim 7, wherein the size of the summary is preserved by automatic adding or removing of segments.

10. The method as claimed in claim 1, wherein the summary is implemented as a play list (900) of segments.

11. A device operable to provide a means to receive user feedback (301) for a selected segment of an initial summary (110), a control means to adjust a degree of influence of each of content characteristics (201) based on the received user feedback (301), a means to derive updated importance scores of at least part of a plurality of segments pertaining to a content item (100) based on said user feedback (301), and a means to update the summary by updating a subset of the plurality of segments based on their respective updated importance scores, said device being operable according to the method claimed in claim 1.

12. A device as claimed in claim 11, being configured to update an initial summary (110) wherein in the updated summary (120) only segments from the segment on which the feedback (301) is provided until the end of the summary are updated.

13. A device as claimed in claim 11, further being operable to enable shortening or extending the summary by adding or removing of at least one segment adjacent to the selected segment.

14. A device as claimed in claim 11, further comprising a means to provide the size of the summary.

15. Software executable on device hardware for implementing a method as claimed in claim 1.
